(19) United States
(12) Patent Application Publication
(10) Pub. No.: US 2023/0082778 A1
(43) Pub. Date: Mar. 16, 2023

(54) Dental Flosser with Multiple Wrapping Strands Utility

(71) Applicant: Scott MacArthur, Lake Forest, IL (US)

(72) Inventor: Scott MacArthur, Lake Forest, IL (US)

(21) Appl. No.: 17/474,647

(22) Filed: Sep. 14, 2021

(51) Int. Cl. A61C 15/04

(52) U.S. Cl. CPC A61C 15/041

(57) ABSTRACT

A floss utility for eliminating debris and plaque between teeth includes a dental flosser with multiple wrapping strands.

### BACKGROUND OF THE INVENTION

### 1. Field of the Invention

A floss system having multiple wrapping strands is provided. The present invention is in the general field of dental hygiene, specifically to floss with multiple floss strands to floss entire spaces between teeth at once using a side to side, lateral motion similar to polishing or shining a shoe using a left hand and a right hand in order to remove plaque and food or other debris from between teeth.

### 2. Discussion of the State of the Art

When people floss, floss is inserted between teeth, and the activity of flossing is well known. Several problems are flossing leaves behind debris, causes gums to bleed, takes time, is not thorough, is boring, and is not fun. Therefore, what is clearly needed is a multiple wrapping floss strands utility with five to ten floss strands that solves the problem mentioned above by utilizing a lateral motion similar to polishing a shoe using a left hand and a right hand.

### SUMMARY OF THE INVENTION

In various embodiments, the present invention comprises floss in a layout consisting of multilayer horizontal adjacent singularly aligned floss strands which can be wrapped around one or more teeth to eliminate debris and plaque between teeth utilizing a side to side, lateral motion similar to polishing a shoe using a left hand and a right hand.

In several embodiments, the number of strands of floss is between 5 and 10 strands although more or fewer may be needed to accommodate larger or smaller mouths.

In several embodiments, each strand of floss is adjacent or very close to adjacent.

In several embodiments, the total width of the strands of floss when viewed in a planar fashion is ½ inch to 1 inch although more or fewer may be needed to accommodate larger or smaller mouths.

In several embodiments, the length of each of the strands of floss is between 5 and 10 inches.

In several embodiments, each strand of floss is typically connected at each end to a solid state object which can be gripped between a user's thumb and fingers. This allows the user to work the strands of floss into the space between teeth and then move the utility laterally from side to side to remove debris.

### BRIEF DESCRIPTION OF THE DRAWINGS

FIG. 1 shows a view of the floss system in accordance with an embodiment of the present invention.

FIG. 2 shows an angular view of the floss system in accordance with an embodiment of the present invention.

FIG. 3 shows a perspective of the floss system FIG. 1 inserted between multiple teeth.

FIG. 4 shows a perspective of the floss system FIG. 1 wrapped around a single tooth.

FIG. 5 shows a perspective of the floss system FIG. 1 inserted between multiple teeth.

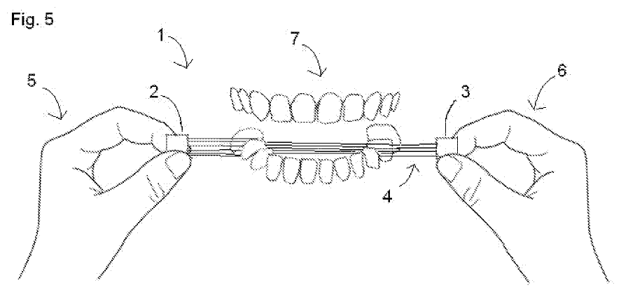

FIG. 6 shows a perspective of the floss system FIG. 1 wrapped around a single tooth.

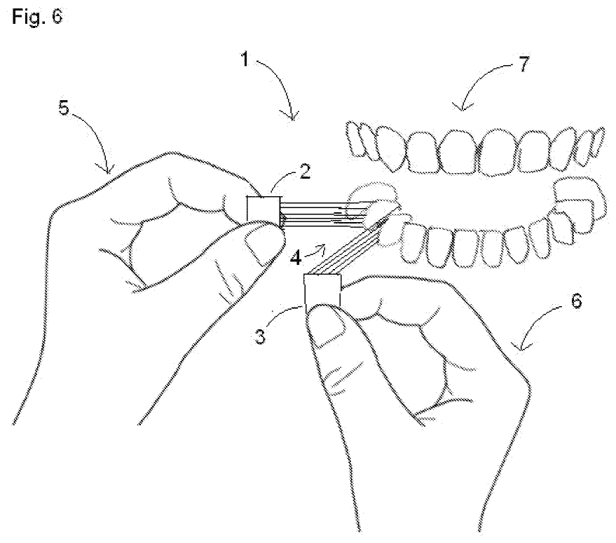

### DETAILED DESCRIPTION

This invention provides a unique utility for flossing teeth. Flossing generally requires a user to use a single strand of floss to attempt to clean debris and plaque from between teeth. A problem is typical flossing leaves behind debris, causes gums to bleed from the abrupt insertion of floss, takes too much time relative to the amount of debris and plaque removed, and is not thorough. A system is thus needed which will provide floss users with an accommodating means for removing plaque and debris. The present invention accommodates common ordinary floss. The present invention is described in enabling detail in the following examples, which may represent more than one embodiment of the present invention.

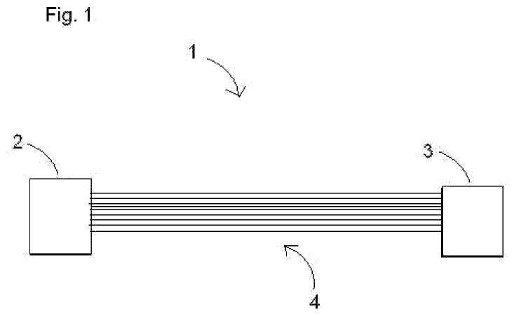

FIG. 1 is a view of the invention (1) having a solid state left side object (2) and a solid state right side object (3) with multiple strands (4) connected to each side.

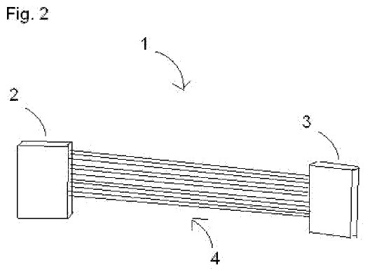

FIG. 2 is an angular view of the invention (1) having a solid state left side object (2) and a solid state right side object (3) with multiple strands (4) connected to each side.

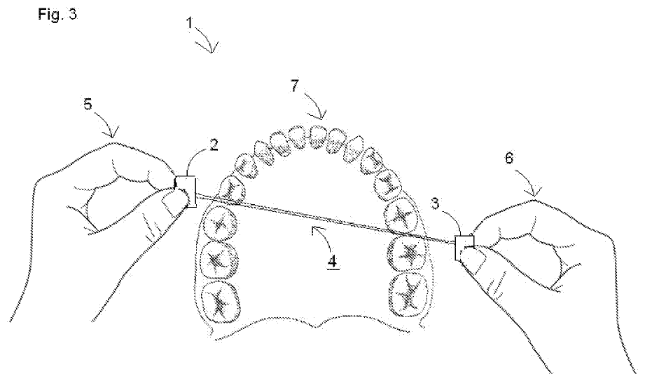

FIG. 3 shows a perspective of the invention (1) in use having a solid state left side object (2) and a solid state right side object (3) with multiple strands (4) connected to each side. The solid state objects are held by each of a left hand (5) and a right hand (6) facilitating the insertion of the multiple strands (4) of the invention (1) between multiple teeth (7).

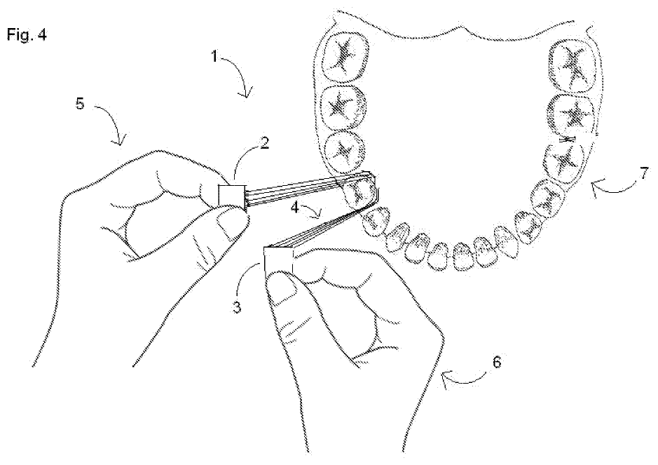

FIG. 4 shows a perspective of the invention (1) in use having a solid state left side object (2) and a solid state right side object (3) with multiple strands (4) connected to each side. The solid state objects are held by each of a left hand (5) and a right hand (6) facilitating the wrapping of the multiple strands (4) of the invention (1) around a single tooth (7).

FIG. 3 shows a perspective of the invention (1) in use having a solid state left side object (2) and a solid state right side object (3) with multiple strands (4) connected to each side. The solid state objects are held by each of a left hand (5) and a right hand (6) facilitating the insertion of the multiple strands (4) of the invention (1) between multiple teeth (7).

FIG. 4 shows a perspective of the invention (1) in use having a solid state left side object (2) and a solid state right side object (3) with multiple strands (4) connected to each side. The solid state objects are held by each of a left hand (5) and a right hand (6) facilitating the wrapping of the multiple strands (4) of the invention (1) around a single tooth (7).

In various embodiments, the present invention comprises floss in multilayer horizontal adjacent singularly aligned wrapping floss strands connected to a solid state left side object and a solid state right side object. The floss lengths and proximities are distinct design elements which may be in various configurations.

In several alternative embodiments, floss may be elongated or shortened to accommodate larger or smaller mouths.

In several alternative embodiments, floss may be adjacent or nearly adjacent to accommodate larger or smaller mouths.

In the above embodiment of the invention, it will be apparent to one with skill in the art or to a person of ordinary skill that the floss system utility of the invention may be provided using some or all of the mentioned features and components without departing from the spirit and scope of the present invention. It will also be apparent to the skilled artisan or person of ordinary skill that the embodiments described above are specific examples of a single broader invention which may have greater scope than any of the singular descriptions taught. There may be many alternatives made in the descriptions without departing from the spirit and scope of the present invention.

1. A floss utility for removing debris between teeth, comprising:
a multilayer horizontal adjacent singularly aligned wrapping floss utility having a left side and a right side utilizing five to ten floss strands with lengths of five to ten inches used in a fashion similar to polishing a shoe when using a left hand and a right hand wherein the width of the group of floss strands when viewed as a plane is one half inch to one inch;
multiple wrapping deformable floss strands which can be bent around one or a plurality of teeth;
two solid state objects on a left side and right side to which the floss strands are connected and which are typically gripped by a user's left thumb and forefinger and said user's right thumb and forefinger.

2. A dental floss apparatus comprising floss and left and right objects in combination providing said dental flosser with multiple wrapping floss utility.

3. A method of encouraging a person to use dental floss, comprising;
providing instructions on the proper steps in teeth flossing, and;
providing a planar of floss strands engaged in an aperture there through and into the mouth of a user, by a determination of said aperture during the tensioning of said planar of floss strands around a single tooth or multiple teeth used in a side to side, lateral flossing motion.
